(19) United States
(12) Patent Application Publication
(10) Pub. No.: US 2019/0246658 A1
(43) Pub. Date: Aug. 15, 2019

(54) METHODS OF HANDLING PAPAYA

(71) Applicant: AGROFRESH INC., Philadelphia, PA (US)

(72) Inventors: Fernando K. EDAGI, Wenatchee, WA (US); Daniel M. BECERRA, Santiago (CL); Nazir MIR, North Brunswick, NJ (US); Evan F. McCASKEY, Ambler, PA (US); Felipe M. TERRA, Campinas Grande (BR); Robert L. McGEE, Midland, MI (US)

(21) Appl. No.: 16/393,211

(22) Filed: Apr. 24, 2019

Related U.S. Application Data
(63) Continuation of application No. 14/191,851, filed on Feb. 27, 2014.
(60) Provisional application No. 61/770,616, filed on Feb. 28, 2013.

(51) Int. Cl. A23B 7/152

(52) U.S. Cl. CPC A23B 7/152

(57) ABSTRACT

Provided is a method of storing papaya comprising the step of exposing papaya to an atmosphere that contains a cyclopropene compound, wherein either (a) the papayas are in a modified-atmosphere package during exposure to the cyclopropene compound, or (b) the papayas are placed into a modified-atmosphere package after exposure to the cyclopropene compound, and the papaya remain in the modified atmosphere package for at least two hours. In some embodiments, the modified-atmosphere package is constructed so that the transmission rate of oxygen for the entire package is from 200 to 40,000 cubic centimeters per day per kilogram of papaya.

### CROSS-REFERENCE TO RELATED APPLICATIONS

This application claims priority under 35 U.S.C. § 119 of U.S. provisional patent application Ser. No. 61/770,616 filed Feb. 28, 2013, which application is hereby incorporated by reference in its entirety.

### FIELD OF THE INVENTION

This invention is generally related to the field of agriculture, and more specifically the field of post-harvest handling of produce.

### BACKGROUND OF THE INVENTION

Papaya tree originally comes from tropical regions, where it was also cultivated. Large-scale plantations are to be found in Ceylon, Pakistan, India, Australia, East Africa and Brasilia. In Mexico and Central America there are just as many plantations, but these are substantially smaller. The tree grows up to six meters in height, the fruits may reach up to 7 kilos in weight.

As a fruit, papayas are very rich in: pectin, vitamins A, B, C, essential fatty acids, bioflavonoids, and phosphotides peptides amino acids (for example arginine). Because papaya is a fruit with high profitability, there remains a need for effective and efficient method to handle and/or preserve papaya for use as both food and medicine.

### SUMMARY OF THE INVENTION

This invention is based on unexpected synergistic effect of a cyclopropene compound and a modified atmosphere package to extend shelf life and/or storage for papaya. Provided is a method of storing papayas comprising the step of exposing papayas to an atmosphere that contains a cyclopropene compound, wherein either (a) the papayas are in a modified-atmosphere package during exposure to the cyclopropene compound, or (b) the papayas are placed into a modified-atmosphere package after exposure to the cyclopropene compound, and the papayas remain in the modified atmosphere package for at least two hours. In some embodiments, the modified-atmosphere package is constructed so that the transmission rate of oxygen for the entire package is from 200 to 40,000 cubic centimeters per day per kilogram of papaya.

In one aspect, provided is a method of handling papayas comprising exposing the papayas to an atmosphere that contains a cyclopropene compound, wherein the papayas are in a modified-atmosphere package during exposure to the cyclopropene compound and the papayas remain in the modified atmosphere package after the exposure for at least two hours.

In one embodiment, the modified-atmosphere package is constructed so that the transmission rate of oxygen for the entire package is from 200 to 40,000 cubic centimeters per day per kilogram of papaya. In a further embodiment, the transmission rate of carbon dioxide for the entire package is from 500 to 150,000 cubic centimeters per day per kilogram of papaya. In another embodiment, the modified-atmosphere package has a GT-30 or GT-25.4 for carbon dioxide at 23° C. from 800 to 150,000 cm³/(m²-day); from 4,000 to 80,000 cm³/(m²-day); or from 1,000 to 60,000 cm³/(m²-day). In another embodiment, the modified-atmosphere package has a GT-30 or GT-25.4 for oxygen at 23° C. from 200 to 150,000 cm³/(m²-day); 1,000 to 80,000 cm³/(m²-day); 3,000 to 40,000 cm³/(m²-day); or 6,000 to 20,000 cm³/(m²-day). In another embodiment, the modified-atmosphere package has a GT-30 or GT-25.4 for water vapor at 37.8° C. from 5 to 1,000 g/(m²-day); 10 to 3300 g/(m²-day); 20 to 150 g/(m²-day); or 50 to 100 g/(m²-day).

In another embodiment, the papaya remain in the modified atmosphere package after the exposure for at least five hours, ten hours, twenty hours, forty hours, four days, seven days, ten days, twenty days, thirty days, or sixty days. In another embodiment, the cyclopropene compound is in a formulation with a molecular encapsulating agent. In a further embodiment, the cyclopropene compound comprises 1-methylcyclopropene (1-MCP). In another embodiment, the molecular encapsulating agent comprises alpha-cyclodextrin, beta-cyclodextrin, gamma-cyclodextrin, or combinations thereof. In a further embodiment, the encapsulated agent comprises alpha-cyclodextrin.

In one embodiment, the cyclopropene compound is of the formula:

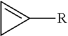

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

In a further embodiment, R is C₁₋₈ alkyl. In another embodiment, R is methyl.

In another embodiment, the cyclopropene compound is of the formula:

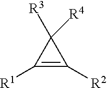

wherein R¹ is a substituted or unsubstituted C₁-C₄ alkyl, C₁-C₄ alkenyl, C₁-C₄ alkynyl, C₁-C₄ cycloalkyl, cylcoalkylalkyl, phenyl, or napthyl group; and R², R³, and R⁴ are hydrogen.

In another embodiment, the concentration of the cyclopropene compound during the exposure is from 10 ppb to 5 ppm. In a further embodiment, the concentration of the cyclopropene compound during the exposure is from 100 ppb to 2 ppm. In a further embodiment, the concentration of the cyclopropene compound during the exposure is from 500 ppb to 1,500 ppb. In a further embodiment, the concentration of the cyclopropene compound during the exposure is about 1,000 ppb. In another embodiment, the firmness of the papaya after the exposure is at least sixteen lbfs after day one or fourteen lbfs after day seven. In another embodiment, shelf life of the papaya after the exposure is at least five days, ten days, fifteen days, twenty days, thirty days, forty days, fifty days, or sixty days. In another embodiment, the papayas are placed in the modified-atmosphere package within two hours, four hours, eight hours, twelve hours, twenty-four hours, or forty-eight hours after harvest.

In another aspect, provided is a method of handling papayas comprising exposing the papayas to an atmosphere that contains a cyclopropene compound, wherein the papayas are placed into a modified-atmosphere package within two hours after exposure to the cyclopropene compound, and the papaya remain in the modified atmosphere package for at least two hours.

In one embodiment, the fruit are treated with a cyclopropene compound, stored/transported to a destination (country), sorted, and then packed in MAP bags.

In one embodiment, the modified-atmosphere package is constructed so that the transmission rate of oxygen for the entire package is from 200 to 40,000 cubic centimeters per day per kilogram of papaya. In a further embodiment, the transmission rate of carbon dioxide for the entire package is from 500 to 150,000 cubic centimeters per day per kilogram of papaya. In another embodiment, the modified-atmosphere package has a GT-30 or GT-25.4 for carbon dioxide at 23° C. from 800 to 150,000 cm³/(m²-day); from 4,000 to 80,000 cm³/(m²-day); or from 1,000 to 60,000 cm³/(m²-day). In another embodiment, the modified-atmosphere package has a GT-30 or GT-25.4 for oxygen at 23° C. from 200 to 150,000 cm³/(m²-day); 1,000 to 80,000 cm³/(m²-day); 3,000 to 40,000 cm³/(m²-day); or 6,000 to 20,000 cm³/(m²-day). In another embodiment, the modified-atmosphere package has a GT-30 or GT-25.4 for water vapor at 37.8° C. from 5 to 1,000 g/(m²-day); 10 to 3300 g/(m²-day); 20 to 150 g/(m²-day); or 50 to 100 g/(m²-day).

In another embodiment, the papayas are placed into a modified-atmosphere package within four hours, eight hours, twelve hours, or twenty hours after exposure to the cyclopropene compound. In another embodiment, the papaya remain in the modified atmosphere package after the exposure for at least ten hours, twenty hours, forty hours, four days, seven days, or ten days. In another embodiment, the cyclopropene compound is in a formulation with a molecular encapsulating agent. In a further embodiment, the cyclopropene compound comprises 1-methylcyclopropene (1-MCP). In another embodiment, the molecular encapsulating agent comprises alpha-cyclodextrin, beta-cyclodextrin, gamma-cyclodextrin, or combinations thereof. In a further embodiment, the encapsulated agent comprises alpha-cyclodextrin.

In one embodiment, the cyclopropene compound is of the formula:

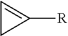

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

In a further embodiment, R is C₁₋₈ alkyl. In another embodiment, R is methyl.

In another embodiment, the cyclopropene compound is of the formula:

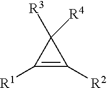

wherein R¹ is a substituted or unsubstituted C₁-C₄ alkyl, C₁-C₄ alkenyl, C₁-C₄ alkynyl, C₁-C₄ cycloalkyl, cylcoalkylalkyl, phenyl, or napthyl group; and R², R³, and R⁴ are hydrogen.

In another embodiment, the concentration of the cyclopropene compound during the exposure is from 10 ppb to 5 ppm. In a further embodiment, the concentration of the cyclopropene compound during the exposure is from 500 ppb to 1,500 ppb. In a further embodiment, the concentration of the cyclopropene compound during the exposure is about 1,000 ppb. In another embodiment, the firmness of the papaya after the exposure is at least sixteen lbfs after day one or fourteen lbfs after day seven. In another embodiment, shelf life of the papaya after the exposure is at least five days, ten days, fifteen days, twenty days, thirty days, forty days, fifty days, or sixty days.

In another aspect, provided is a system for handling papaya comprising (a) a cyclopropene compound, wherein the cyclopropene compound is applied to the papaya at a concentration from 10 ppb to 5 ppm; and (b) a modified-atmosphere package, wherein the modified-atmosphere package is constructed so that the transmission rate of oxygen for the entire package is from 200 to 40,000 cubic centimeters per day per kilogram of papaya. In a further embodiment, the transmission rate of carbon dioxide for the entire package is from 500 to 150,000 cubic centimeters per day per kilogram of papaya. In another embodiment, the modified-atmosphere package has a GT-30 or GT-25.4 for carbon dioxide at 23° C. from 800 to 150,000 cm³/(m²-day); from 4,000 to 80,000 cm³/(m²-day); or from 1,000 to 60,000 cm³/(m²-day). In another embodiment, the modified-atmosphere package has a GT-30 or GT-25.4 for oxygen at 23° C. from 200 to 150,000 cm³/(m²-day); 1,000 to 80,000 cm³/(m²-day); 3,000 to 40,000 cm³/(m²-day); or 6,000 to 20,000 cm³/(m²-day). In another embodiment, the modified-atmosphere package has a GT-30 or GT-25.4 for water vapor at 37.8° C. from 5 to 1,000 g/(m²-day); 10 to 3300 g/(m²-day); 20 to 150 g/(m²-day); or 50 to 100 g/(m²-day).

In another embodiment, the cyclopropene compound is in a formulation with a molecular encapsulating agent. In a further embodiment, the cyclopropene compound comprises 1-methylcyclopropene (1-MCP). In another embodiment, the molecular encapsulating agent comprises alpha-cyclodextrin, beta-cyclodextrin, gamma-cyclodextrin, or combinations thereof. In a further embodiment, the encapsulated agent comprises alpha-cyclodextrin.

In one embodiment, the cyclopropene compound is of the formula:

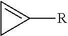

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

In a further embodiment, R is C₁₋₈ alkyl. In another embodiment, R is methyl.

In another embodiment, the cyclopropene compound is of the formula:

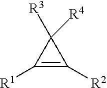

wherein R¹ is a substituted or unsubstituted C₁-C₄ alkyl, C₁-C₄ alkenyl, C₁-C₄ alkynyl, C₁-C₄ cycloalkyl, cylcoalkylalkyl, phenyl, or napthyl group; and R², R³, and R⁴ are hydrogen.

In another embodiment, the cyclopropene compound is applied to the papaya at a concentration about 1,000 ppb. In another embodiment, the firmness of the papaya after treatment with the system provided is at least sixteen lbfs after day one or fourteen lbfs after day seven. In another embodiment, shelf life of the papaya after the treatment with the system provided is at least five days, ten days, fifteen days, twenty days, thirty days, forty days, fifty days, or sixty days.

### BRIEF DESCRIPTION OF THE DRAWINGS

FIG. 1 shows representative firmness results of the papayas after four (4) days at 22° C. after treatment with the method provided in Example 1 (RipeLock), modified atmosphere package alone (MAP), cyclopropene compound alone (SmartFresh), or control (without neither modified atmosphere package nor cyclopropene compound). Percentages of papayas with ideal internal pulp firmness are indicated. Treated papayas are stored at 11° C. for 27 days to simulate transportation/storage and then placed at 22° C. to simulate shelf-life.

FIG. 2 shows representative firmness results of the papayas after twenty-six (26) at 11° C. after treatment with the method provided in Example 2 (RipeLock), modified atmosphere package alone (MAP), cyclopropene compound alone (SmartFresh), or control (without neither modified atmosphere package nor cyclopropene compound). Percentages of papayas with ideal internal pulp firmness are indicated.

FIG. 3 shows representative firmness results of the papaya four (4) days stored at 22° C. after treatment according to results of FIG. 2. Percentages of papayas with ideal internal pulp firmness are indicated.

### DETAILED DESCRIPTION OF THE INVENTION

When a compound is described herein as being present as a gas in an atmosphere at a certain concentration using the unit “ppm,” the concentration is given as parts by volume of that compound per million parts by volume of the atmosphere. Similarly, “ppb” denotes parts by volume of that compound per billion parts by volume of the atmosphere.

As used herein “N” denotes Newtons, and “lbf” is pounds-force.

As used herein, a “polymeric film” is an object that is made of polymer; that is much smaller in one dimension (the “thickness”) than in the other two dimensions; and that has a relatively uniform thickness. Polymeric film typically has thickness of 1 mm or less.

As used herein, the “pulp firmness” of papaya is measured using a penetrometer (for example Fruit Test™ FT40 penetrometer, from Wagner Instruments) having a plunger diameter of 8 mm. Performing the test for pulp firmness destroys the papaya that is tested. When papayas are said herein to be treated in a certain way (e.g., harvested, shipped, exposed to a cyclopropene compound, etc.) when they have a certain specified pulp firmness, it is meant that, out of a group of papaya that have been harvested and treated as uniformly as reasonably possible, a sample of a relatively small number of papaya is removed and tested for pulp firmness. The large group of papaya is considered to have the pulp firmness that is the average value of the tests performed on the relatively small sample.

The present invention involves the use of one or more cyclopropene compound. As used herein a cyclopropene compound is any compound with the formula

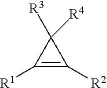

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (i.e., any one of R¹, R², R³ and R⁴) the total number of heteroatoms (i.e., atoms that are neither H nor C) is from 0 to 6.

Independently, in any one R group the total number of non-hydrogen atoms is 50 or less.

Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³ and R⁴ groups are independently selected from the suitable groups. The R¹, R², R³ and R⁴ groups may be the same as each other, or any number of them may be different from the others. Groups that are suitable for use as one or more of R¹, R², R³ and R⁴ may be connected directly to the cyclopropene ring or may be connected to the cyclopropene ring through an intervening group such as, for example, a heteroatom-containing group.

As used herein, a chemical group of interest is said to be “substituted” if one or more hydrogen atoms of the chemical group of interest is replaced by a substituent. Suitable substituents include, for example, alkyl, alkenyl, acetylamino, alkoxy, alkoxyalkoxy, alkoxycarbonyl, alkoxyimino, carboxy, halo, haloalkoxy, hydroxy, alkylsulfonyl, alkylthio, trialkylsilyl, dialkylamino, and combinations thereof.

Among the suitable R¹, R², R³ and R⁴ groups are, for example, substituted and unsubstituted versions of any one of the following groups: aliphatic, aliphatic-oxy, alkylcarbonyl, alkylphosphonato, alkylphosphato, alkylamino, alkylsulfonyl, alkylcarboxyl, alkylaminosulfonyl, cycloalkylsulfonyl, cycloalkylamino, heterocyclyl (i.e., aromatic or non-aromatic cyclic groups with at least one heteroatom in the ring), aryl, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl; butylmercapto, diethylphosphonato, dimethylphenylsilyl, isoquinolyl, mercapto, naphthyl, phenoxy, phenyl, piperidino, pyridyl, quinolyl, triethylsilyl, and trimethylsilyl.

Among the suitable R¹, R², R³ and R⁴ groups are those that contain one or more ionizable substituent groups. Such ionizable groups may be in non-ionized form or in salt form.

Also contemplated are embodiments in which R³ and R⁴ are combined into a single group, which is attached to the number 3 carbon atom of the cyclopropene ring by a double bond. Some of such compounds are described in US Patent Publication 2005/0288189.

In preferred embodiments, one or more cyclopropenes are used in which one or more of R¹, R², R³ and R⁴ is hydrogen. In more preferred embodiments, each of R¹, R², R³ and R⁴ is hydrogen or (C₁-C₈) alkyl. In more preferred embodiments, R¹ is substituted or unsubstituted (C₁-C₈) alkyl, and each of R², R³, and R⁴ is hydrogen. In more preferred embodiments, each of R², R³, and R⁴ is hydrogen, and R¹ is either unsubstituted (C₁-C₄) alkyl or a carboxyl-substituted (C₁-C₈) alkyl. In more preferred embodiments, each of R², R³, and R⁴ is hydrogen, and R¹ is unsubstituted (C₁-C₄) alkyl. In more preferred embodiments, R¹ is methyl and each of R², R³, and R⁴ is hydrogen, and the cyclopropene compound is known herein as 1-methylcycplopropene or “1-MCP.”

In preferred embodiments, a cyclopropene compound is used that has boiling point at one atmosphere pressure of 50° C. or lower; or 25° C. or lower; or 15° C. or lower. Independently, in preferred embodiments, a cyclopropene compound is used that has boiling point at one atmosphere pressure of −100° C. or higher; −50° C. or higher; or 25° C. or higher; or 0° C. or higher.

As used herein, “modified-atmosphere packaging” or “MAP” refers to an enclosure that alters the gaseous atmosphere inside the enclosure from normal atmospheric composition when respiring produce is contained inside the enclosure. MAP is an enclosure in the sense that it is a package that may be lifted and transported with the produce contained within it. MAP may or may not allow exchange of gas with the ambient atmosphere outside the MAP. MAP may or may not be permeable to diffusion of any particular gas, independent of its permeability or non-permeability to any other gas.

As used herein, a “monomer” is a compound that has one or more carbon-carbon double bond that is capable of participating in a polymerization reaction. As used herein, an “olefin monomer” is a monomer, the molecules of which contain only atoms of carbon and hydrogen. As used herein, “polar monomer” is a monomer, the molecules of which contain one or more polar group. Polar groups include, for example, hydroxyl, thiol, carbonyl, carbon-sulfur double bond, carboxyl, sulfonic acid, ester linkages, other polar groups, and combinations thereof.

In the methods provided herein, papayas are exposed to an atmosphere that contains one or more cyclopropene compound. Cyclopropene compound may be introduced into the atmosphere surrounding the papaya by known methods in the art. For example, gaseous cyclopropene compound may be released into the atmosphere in such close proximity to papaya that the cyclopropene compound contacts the papaya before the cyclopropene diffuses far away from the papaya. For another example, the papaya may be in an enclosure (i.e., and airtight container enclosing a volume of atmosphere), and gaseous cyclopropene compound may be introduced into the enclosure.

In some embodiments, the papayas are inside a permeable surrounding device, and cyclopropene compound is introduced into the atmosphere outside the permeable surrounding device. In such embodiments, the permeable surrounding device encloses one or more papaya and allows some contact between the cyclopropene compound and the papaya, for example by allowing some cyclopropene compound to diffuse through the permeable surrounding device or through holes in the permeable surrounding device or a combination thereof. Such a permeable surrounding device may or may not also qualify as an MAP as defined herein.

Among embodiments in which gaseous cyclopropene compound is introduced into an enclosure, the introduction may be performed by known methods in the art. For example, the cyclopropene compound may be created in a chemical reaction and vented to the enclosure. For another example, cyclopropene compound may be kept in a container such as a compressed-gas tank and released from that container into the enclosure. For another example, cyclopropene compound may be contained in a powder or pellets or other solid form that contains encapsulated complex of cyclopropene compound in a molecular encapsulating agent. A complex that includes a cyclopropene compound molecule or a portion of a cyclopropene compound molecule encapsulated in a molecule of a molecular encapsulating agent is known herein as a “cyclopropene compound complex” or “cyclopropene molecular complex.”

In embodiments in which a molecular encapsulating agent is used, suitable molecular encapsulating agents include, for example, organic and inorganic molecular encapsulating agents. Organic molecular encapsulating agents are provided include, for example, substituted cyclodextrins, unsubstituted cyclodextrins, and crown ethers. Suitable inorganic molecular encapsulating agents include, for example, zeolites. Mixtures of suitable molecular encapsulating agents are also suitable. In one embodiment, the encapsulation agent is selected from the group consisting of alpha cyclodextrin, beta cyclodextrin, gamma cyclodextrin, substituted versions thereof, and combinations thereof. In a further embodiment, the cyclopropene compound is 1-methylcyclopropene, and the encapsulation agent is alpha cyclodextrin. The choice of encapsulation agent will vary depending upon the structure of the cyclodextrin compound or compounds being used. Any cyclodextrin or mixture of cyclodextrins, cyclodextrin polymers, modified cyclodextrins, or mixtures thereof can also be utilized pursuant to the present invention.

In some embodiments, a cyclopropene compound is introduced into an enclosure that contains papaya by placing cyclopropene molecular complex into the enclosure and then contacting the cyclopropene molecular complex with a release agent. A release agent is a compound that, when it contacts cyclopropene encapsulation complex, promotes the release of the cyclopropene compound into the atmosphere. Among embodiments in which alpha-cyclodextrin is used, water (or a liquid that contains 50% or more water by weight, based on the weight of the liquid) is the exemplary release agent.

In some embodiments, a solid material containing cyclopropene molecular complex is placed into an enclosure that contains papaya, and water is brought into contact with that solid material. Contact with the water causes release of cyclopropene compound into the atmosphere of the enclosure. For example, the solid material may be in the form of tablets that contain, optionally among other ingredients, encapsulation complex that contains a cyclopropene compound and one or more ingredients that causes effervescence.

For another example, in some embodiments the solid material may be placed into an enclosure that contains papaya and water vapor in the atmosphere may be effective as a release agent. In some of such embodiments, the solid material that contains cyclopropene encapsulated complex may be in a form that also contains, optionally among other ingredients, a water-absorbing compound such as, for example, a water-absorbing polymer or a deliquescent salt.

In some embodiments, atmosphere containing one or more cyclopropene compound in gaseous form is in contact with papaya or is in contact with a permeable surrounding device that surrounds one or more papaya. In such embodiments, all concentrations above zero of cyclopropene compound are contemplated. For example, the concentration of cyclopropene compound is 10 ppb or higher; more preferably is 30 ppb or higher; more preferably is 100 ppb or higher. For additional examples, the concentration of cyclopropene compound is 50 ppm or lower, more preferably 10 ppm or lower, more preferably 5 ppm or lower.

MAP may be active or passive. Active MAP is packaging that is attached to some material or apparatus that adds certain gas or gases to the atmosphere inside the MAP and/or removes certain gas or gases from the atmosphere inside the MAP.

Passive MAP (also called commodity generated modified atmosphere packaging) takes advantage of the fact that papaya respire after harvest. Thus papaya placed in an enclosure, among other processes, consume oxygen and produce carbon dioxide. The MAP can be designed so that diffusion through the solid exterior surfaces of the MAP and passage of gas through any perforations that may be present in the exterior surface of the MAP maintain optimum levels of oxygen, carbon dioxide, and optionally other gases (such as, for example, water vapor or ethylene or both). In one embodiment, passive MAP is used. In another embodiment, active MAP is used. In another embodiment, both active and passive MAPs are used. For example, if it is stated herein that an MAP has a certain gas transmission characteristic, both of the following embodiments are contemplated: a passive MAP that has that gas transmission characteristic; and an active MAP that, when it contains papaya, maintains the same atmosphere within itself that would occur in a passive MAP that had that gas transmission characteristic.

A useful way to characterize the MAP is the gas transmission rate of the MAP itself in relation to the amount of papaya held in the MAP. Preferably, the rate of transmission of carbon dioxide is, in units of cubic centimeters per day per kilogram of papaya, 5,000 or higher; more preferably 7,000 or higher; more preferably 10,000 or higher. Preferably, the rate of transmission of carbon dioxide is, in units of cubic centimeters per day per kilogram of papaya, 150,000 or lower; more preferably 100,000 or lower. Preferably, the rate of transmission of oxygen is, in units of cubic centimeters per day per kilogram of papaya, 3,800 or higher; more preferably 7,000 or higher; more preferably 15,000 or higher. Preferably, the rate of transmission of oxygen is, in units of cubic centimeters per day per kilogram of papaya, 100,000 or lower; or 75,000 or lower.

It is useful to characterize the inherent gas transmission characteristics of a polymeric film. By “inherent” it is meant the properties of the film itself, in the absence of any perforations or other alterations. It is useful to characterize the composition of a film by characterizing the gas transmission characteristics of a film that has that composition and that is 30 or 25.4 micrometers thick. It is contemplated that, if a film of interest were made and tested at a thickness that was different from 30 or 25.4 micrometers (e.g., from 20 to 40 micrometers), it would be easy for a person of ordinary skill to accurately calculate the gas transmission characteristics of a film having the same composition and having thickness of 30 or 25.4 micrometers. The gas transmission rate of a film having thickness 30 micrometers is labeled “GT-30” herein. The gas transmission rate of a film having thickness 25.4 micrometers is labeled “GT-25.4” herein

One useful inherent characteristic of a polymeric film composition is herein called “film beta ratio,” which is the quotient that is calculated by dividing the GT-30 or GT-25.4 for carbon dioxide gas transmission rate by the GT-30 or GT-25.4 for oxygen gas.

In one embodiment, some or all of the exterior surfaces of the MAP are polymeric. In another embodiment, the polymer is in the form of a polymeric film. Some suitable polymeric films have thickness of 5 micrometer or more; or 10 micrometer or more; or 20 micrometer or more. Independently, some suitable polymeric films have thickness of 200 micrometer or less; or 100 micrometer or less; or 50 micrometer or less.

Some suitable polymer compositions include, for example, polyolefins, polyvinyls, polystyrenes, polydienes, polysiloxanes, polyamides, vinylidene chloride polymers, vinyl chloride polymers, copolymers thereof, blends thereof, and laminations thereof. Suitable polyolefins include, for example, polyethylenes, polypropylenes, copolymers thereof, blends thereof, and laminations thereof. Suitable polyethylenes include, for example, low density polyethylene, ultralow density polyethylene, linear low density polyethylene, metallocene-catalyzed polyethylene, copolymers of ethylene with polar monomers, medium density polyethylene, high density polyethylene, copolymers thereof and blends thereof. Suitable polypropylenes include, for example, polypropylene and oriented polypropylene. In some embodiments, low density polyethylene is used. In one embodiment, copolymer of styrene and butadiene is used. In another embodiment, polyamides, polyolefins, and blends thereof are used.

Among polyolefins, one example is polyethylene; and another example is metallocene-catalyzed polyethylene. Other examples include polymer compositions comprising one or more polyolefin and/or one or more copolymer of an olefin monomer with a polar monomer. The phrase “copolymer” refers to a product of copolymerizing two or more different monomers. Suitable copolymers of an olefin monomer with a polar monomer include, for example, such polymers available from DuPont called Elvax™ resins. One embodiment includes copolymers of ethylene with one or more polar monomer. Suitable polar monomers include, for example, vinyl acetate, methyl acrylate, ethyl acrylate, butyl acrylate, acrylic acid, methacrylic acid, and mixtures thereof. For one example polar monomers contain one or more ester linkage; for another example is vinyl acetate. Among copolymers of ethylene with one or more polar monomer, the amount of polar monomer may be, by weight based on the weight of the copolymer, 0.5% or more; for example 1% or more; or 1.5% or more. Among copolymers of ethylene with one or more polar monomer, the amount of polar monomer may be, by weight based on the weight of the copolymer, 25% or less; for example 20% or less; or 15% or less.

Suitable polyolefins include blends of a polyolefin homopolymer with a copolymer of an olefin monomer with a polar monomer. Among such blends, the weight ratio of homopolymer to copolymer may be 0.5:1 or higher; for example 0.8:1 or higher; or 1:1 or higher. Among such blends, the weight ratio of homopolymer to copolymer may be 3:1 or lower; for example 2:1 or lower; or 1.25:1 or lower.

In one embodiment, the weight ratio % of homopolymer to copolymer may be from 90/10 to 50/50. In another embodiment, the weight ratio % of homopolymer to copolymer may be about 80/20, 75/25, 70/30, or 60/40. In another embodiment, the weight ratio % of homopolymer to copolymer may be from 50/50 to 10/90. In another embodiment, the weight ratio % of homopolymer to copolymer may be about 20/80, 25/75, 30/70, or 40/60.

Suitable polyamides include nylon 6, nylon 6,6, and copolymers thereof; for example copolymers of nylon 6 with nylon 6,6. Among copolymers of nylon 6 with nylon 6,6 (often called nylon 666), examples include copolymers in which the weight ratio of polymerized units of nylon 6 to polymerized units of nylon 6,6 may be 0.05:1 or higher; 0.11:1 or higher; or 0.25:1 or higher. Among copolymers of nylon 6 with nylon 6,6, examples include copolymers in which the weight ratio of polymerized units of nylon 6 to polymerized units of nylon 6,6 may be 9:1 or lower; 3:1 or lower; or 1.5:1 or lower.

Suitable blends of polyamide with polyolefin include blends in which the weight ratio of polyamide to polyolefin may be 0.05:1 or higher; 0.11:1 or higher; 0.25:1 or higher; or 0.5:1 or higher. Suitable blends of polyamide with polyolefin include blends in which the weight ratio of polyamide to polyolefin may be 9:1 or lower; 5:1 or lower; or 3:1 or lower.

In one embodiment, the weight ratio % of polyamide to polyolefin may be from 70/30 to 30/70; or 60/40 to 40/60. In another embodiment, the weight ratio % of polyamide to polyolefin may be about 80/20, 70/30, 60/40, 50/50, 40/60, 30/70, or 20/80.

When it is stated herein that a container comprises polymeric film, it is meant that some or all of the surface area of the container consists of polymeric film, and the film is arranged so that molecules that are capable of diffusing through the polymeric film will diffuse between the inside of the container and the outside of the container in both directions. Such a container may be constructed so that one, two, or more separate portions of the surface area of the container consist of polymeric film, and the polymeric film portions may be the same composition as each other or may be different from each other. It is contemplated that such containers will be constructed so that the portion of the container surface that is not polymeric film will effectively block diffusion of gas molecules (i.e., the amount of gas molecules that diffuse through will be of negligible importance).

Suitable polyolefin films include film compositions for which the GT-30 or GT-25.4 for carbon dioxide at 23° C., in units of cm³/(m²-day), may be 800 or higher; 4,000 or higher; 5,000 or higher; 10,000 or higher; or 20,000 or higher. Example include films with GT-30 or GT-25.4 for carbon dioxide at 23° C., in units of cm³/(m²-day), of 150,000 or lower; 80,000 or lower; or 60,000 or lower. Other examples include films with GT-30 or GT-25.4 for oxygen at 23° C., in units of cm³/(m²-day), of 200 or higher; 1,000 or higher; 3,000 or higher; or 6,000 or higher. Other examples include films with GT-30 or GT-25.4 for oxygen at 23° C., in units of cm³/(m²-day), of 150,000 or lower; 80,000 or lower; 40,000 or lower; 20,000 or lower; or 15,000 or lower. Other examples include films with GT-30 or GT-25.4 for water vapor at 37.8° C., in units of g/(m²-day), of 5 or higher; or 10 or higher. Other examples include films with GT-30 or GT-25.4 for water vapor at 37.8° C., in units of g/(m²-day), of 330 or lower; 150 or lower; 100 or lower; 55 or lower; 45 or lower; or 35 or lower. In one embodiment, film has film beta ratio of 1 or higher; or 2 or higher. In another embodiment, film has beta ratio of 15 or lower; or 10 or lower.

Polyamide films, as used herein, includes films containing polyamide and films containing a blend of polyamide with one or more other polymer. Suitable polyamide films include films with GT-30 or GT-25.4 for water vapor at 37.8° C., in units of g/(m²-day), of 10 or higher; or 20 or higher. Examples include films with GT-30 or GT-25.4 for water vapor at 37.8° C., in units of g/(m²-day), of 1,000 or lower; 800 or lower; 500 or lower; 350 or lower; or 200 or lower.

It is contemplated that the GT-30 or GT-25.4 for oxygen and the GT-30 for carbon dioxide are both very low for polyamide films. It is contemplated that when MAP is used that is made of a film that is made of polyamide or a blend of polyamide with other polymer(s), the film will be perforated in a way that is chosen to provide the desired gas transmission characteristics of the MAP itself.

In one embodiment, polymeric film is used that has perforations. In a further embodiment, the holes have mean diameter of 5 micrometers to 500 micrometers. In another embodiment involving perforations, the holes may have mean diameter of 10 micrometers or more; 20 micrometers or more; 50 micrometers or more; or 100 micrometers or more. Independently, in another embodiment involving perforations, the holes may have mean diameter 300 micrometers or less; or 200 micrometers or less. If a hole is not circular, the diameter of the hole is considered herein to be 2 times the square root of the quotient of the area of the hole divided by pi.

In one embodiment, the MAP comprises polymeric film, and the percent of the surface area of the MAP that consists of the polymeric film may be 10% to 100%; 50% to 100%; 75% to 100%; or 90% to 100%. An MAP in which 90% to 100% of the surface area consists of polymeric film is known herein as a “bag.” Example include MAP that comprise polymeric film and in which all portions of the surface of the MAP that are not polymeric film effectively block diffusion of gas molecules. In embodiments in which the MAP comprises polymeric film and the remainder (if any) of the surface of the MAP effectively blocks diffusion of gas molecules, the MAP is considered to be passive MAP.

Holes in polymeric film may be made by methods known in the art. Suitable methods include, for example, laser perforation, hot needles, flame, low-energy electrical discharge, and high-energy electrical discharge. In one embodiment, such method is laser perforation.

Another useful way to characterize an MAP is the “MAP beta ratio,” which is defined herein as the quotient that results from dividing the rate of transmission of carbon dioxide of the MAP by the rate of transmission of oxygen of the MAP itself. In one embodiment, the MAP beta ratio may be 0.3 or higher; or 0.5 or higher. In another embodiment, the MAP beta ratio may be 5 or lower; 3 or lower; or 2 or lower. In another embodiment, when the MAP is made entirely of polyolefin film, the MAP beta ratio is 1.0 to 1.6. In another embodiment, when the MAP is made entirely of polyamide film, the MAP beta ratio is 0.5 to 0.999. In another embodiment, when the MAP is made of a film that contains a blend of polyamide and polyolefin, the MAP beta ratio is 0.6 to 1.2.

In one embodiment, papayas are harvested when they are mature but not yet ripe. In another embodiment, the papayas are harvested when the dry matter content, by weight based on the weight of the papaya, is 17% or higher.

In one embodiment, papayas are harvested and immediately (for example within two hours) placed into MAP before exposure to the cyclopropene compound. In another embodiment, the time from harvest to placement into MAP may be 30 days or less; 14 days or less; 7 days or less; or 2 days or less. In another embodiment, harvested papayas are placed into MAP after exposure to the cyclopropene compound and prior to shipment, and the harvested papaya remain in the MAP during shipment.

In one embodiment, papayas are harvested and, prior to being placed into MAP, the papayas are placed in pre-shipment storage. Such pre-shipment storage may be below room temperature, for example 15° C. or lower; or 7° C. or lower. After such storage, the papaya may be placed in to MAP and then shipped to their destination.

In another embodiment, papayas are shipped to a destination that is near the intended point of consumption or else are harvested near the intended point of consumption and/or sale. As used herein, “near the intended point of consumption and/or sale” means a location from which it is capable to transport the papaya to the point of consumption in 3 days or fewer by truck or other surface transportation.

In one embodiment where papayas are placed into a modified-atmosphere package after exposure to the cyclopropene compound (for example, papayas are exposed to an atmosphere that contains a cyclopropene compound while the papayas are not in an MAP), papayas are placed into an MAP after the conclusion of the exposure to the atmosphere that contains a cyclopropene compound, and the papaya then remain in the MAP for at least two hours.

In another embodiment where papayas are placed into a modified-atmosphere package after exposure to the cyclopropene compound, the papayas are kept at temperature of 10° C. or above from the conclusion of the exposure to the atmosphere that contains a cyclopropene compound until the papayas are placed into the MAP. In a further embodiment, the time period from the conclusion of the exposure to the atmosphere that contains a cyclopropene compound until the papayas are placed into the MAP may be eight hours or less; four hours or less; two hours or less; or 1 hour or less.

In another embodiment where papayas are placed into a modified-atmosphere package after exposure to the cyclopropene compound, the papayas are kept at temperature below 10° C. from the conclusion of the exposure to the atmosphere that contains a cyclopropene compound until the papayas are placed into the MAP. In a further embodiment, the temperature at which papayas are kept from the conclusion of the exposure to the atmosphere that contains a cyclopropene compound until the papayas are placed into the MAP may be 7° C. or lower. In another further embodiment, the time period from the conclusion of the exposure to the atmosphere that contains a cyclopropene compound until the papayas are placed into the MAP may be between ten minutes to two months.

In one embodiment where the papayas are in a modified-atmosphere package during exposure to the cyclopropene compound (for example, papayas are exposed to an atmosphere that contains a cyclopropene compound while the papayas are in a MAP), there is an improvement in the pulp firmness retention of the papaya that can be seen even on completion of the exposure of the papaya to the cyclopropene compound.

In another embodiment where the papayas are in a modified-atmosphere package during exposure to the cyclopropene compound, papayas are in an MAP for a time period of duration of 1 day or more, where that time period is after harvest and before exposure to atmosphere containing a cyclopropene compound (herein called a “pre-X” time period). In a further embodiment, composition of the MAP comprises polyamide.

In some embodiments, the papaya reside in an MAP for a storage time period that begins within 1 hour of the conclusion of the exposure to atmosphere containing cyclopropene compound (herein called a “post-X” time period). For example, post-X storage time period may begin within thirty minutes of the conclusion of the exposure to cyclopropene compound; within fifteen minutes; within eight minutes; or within one minute.

In another embodiment where the papayas are in a modified-atmosphere package during exposure to the cyclopropene compound, the papayas are in an MAP during exposure to atmosphere containing cyclopropene compound; if the papaya remain in the MAP thereafter without being removed from the MAP, the post-X storage time period is considered to begin immediately upon the conclusion of the exposure to atmosphere containing cyclopropene compound. For example, the post-X storage time period may last for one day or longer; or 2 days or longer.

By “conclusion of exposing the papaya to a cyclopropene compound,” it is meant herein a time after which papaya have been exposed to a cyclopropene compound as described herein and at which the concentration of cyclopropene compound in the atmosphere around the papaya (or the atmosphere around the permeable surrounding device, if the papaya were in a permeable surrounding device during exposure to cyclopropene compound) falls below 0.5 ppb.

In some embodiments, suitable MAP is chosen or designed so that, when papayas are placed into the MAP and the MAP, with the papaya inside, is then exposed to atmosphere containing cyclopropene compound, and then stored for 10 days at 16.7° C., a certain pre-determined atmosphere will be present in the MAP. In one embodiment with the pre-determined atmosphere, the amount of carbon dioxide, by volume based on the volume of the atmosphere inside the MAP, may be 1% or more; or 5% or more. In another embodiment with the pre-determined atmosphere, the amount of carbon dioxide, by volume based on the volume of the atmosphere inside the MAP, may be 20% or less; or 15% or less. In another embodiment with the pre-determined atmosphere, the amount of oxygen, by volume based on the volume of the atmosphere inside the MAP, may be 1% or more; 3% or more; or 5% or more. In another embodiment with the pre-determined atmosphere, the amount of oxygen, by volume based on the volume of the atmosphere inside the MAP, may be 20% or less; or 15% or less.

The Oxygen Transmission Rate or OTR for a modified atmosphere package can be calculated from the work presented in literature or measured directly. For a microperforated polymer bag the OTR due to the permeability of the film at any given time can be theoretically calculated using Fick's law of diffusion where the permeability coefficient for the polymer film can be measured using a procedure as called out in ASTM method D3985 for O₂. For this same microperforated bag the OTR due to the microperforations can be calculated using a modified Fick's law of diffusion. The OTR at any given time is dependent on the O₂ concentration driving force at that point of time. The OTR of the system can be measured by measuring the O₂ partial pressure versus time and then plotting the natural log of the concentration gradient versus time. This is a convenient method in cases where there are not well validated models for the OTR such as microporous systems or unique combinations of approaches such as microporous patches combined with films or microperforated films.

### EXAMPLES

### Example 1

Papayas ‘Golden’ were harvested in Linhares—Espírito Santo—Brazil. The harvested fruits were packed in MAP Bags and put in cardboard boxes.

The appropriate weight of papayas was placed in each bag after harvest. Bags were placed in the same cardboard boxes used to export the fruits. Papayas then were cold stored at (11° C.) at the Laboratory.

The Test Protocol that was used was as follows. 36 MAP bags were packed. Each bag held approximately 3.8 kg (8.4 lb) of papayas. One such bag was packed in each cardboard box. Total weight of papayas in MAP bags was approximately 137 kg. Approximately 91 kg of papayas were placed into cardboard boxes identical to those used for the MAP bags.

The MAP-packaged papayas were packaged as follows: Nine fruits, approximately 3.8 kg were carefully placed into microperforated bags, and the bags were sealed by twisting the open side of the bag, folding down the twisted end, and placing a rubber band around the twisted and folded end of the bag.

The papayas were randomly divided into treatment sets as follows:

TABLE 1
Papaya treatment in this example

MCP Concentration

| Number of CBs | Bag Type | 0 ppb | 100 ppb |
|---|---|---|---|
| 24 CBs | No MAP | 12 CBs | 12 CBs |
| 36 CBs | MAP Bag | 12 CBs | 12 CBs |

Papayas are harvest in an early mature stage with a high firmness. According to the FTA Machine (Firmness Texture Analyzer), the fruits have pulp internal firmness around 18 lbf and/or external firmness around 25 lbf one day after harvest.

All papayas were kept at cold temperature (11° C.) during 27 days and after that the fruits (packed in MAP bags or not) were put in room temperature (22° C.) during 8 days.

Bags were not opened until the day of the evaluation. Temperature was monitored in some of the cardboard boxes (CB) by placing a temperature monitor inside of the container.

The RipeLock treatment group with MAP bags and with non-zero MCP are examples of the present invention. All other treatment groups are comparative.

One day after harvest, when the papayas had around 25 lbf of average firmness, each treatment set was marked, placed in a hermetical chamber at cold temperature (11° C.). All chambers were of equal size and packed the same way. Treatment was for 12 hours. In the chambers for the 3 “MCP” treatment groups, at the beginning of the treatment period, SmartFresh™ were placed in the chamber. The amount of SmartFresh™ was chosen to achieve the indicated concentration of 1-methylcyclopropene in the atmosphere of the chamber.

After the treatment in the chambers, the cardboard boxes were moved into racks at positioned inside the cold rooms for storage and observation.

TABLE 2-1
Skin Color ratings

| | | Days @ 22° C. | | |
|---|---|---|---|---|
| Bag | ppb of MCP | 0 | 4 | 8 |
| No Bag | 0 | 2.08 | 4.41 | 4.05 |
| No Bag | 100 | 1.70 | 4.28 | 4.44 |
| MAP | 0 | 2.20 | 3.08 | 3.33 |
| MAP | 100 | 2.14 | 2.74 | 3.46 |

Papayas remained in the same bags throughout the packing, treatment in the chamber, and subsequent storage.

TABLE 2-2
Pulp Firmness - External (lbf)

| | | Days @ 22° C. | | |
|---|---|---|---|---|
| Bag | ppb of MCP | 0 | 4 | 8 |
| No Bag | 0 | 22.9 | 2.0 | 1.4 |
| No Bag | 100 | 25.0 | 23.4 | 7.8 |
| MAP | 0 | 12.3 | 7.1 | 3.4 |
| MAP | 100 | 17.1 | 17.0 | 6.2 |

Evaluation for skin color and firmness was as follows. Day “zero” was the day the papayas were removed from the chamber and placed in storage.

The Papaya Skin Color was rated with the following scale: 1: green; 2: approximately 25%; 3: approximately 50% colored; 4: approximately 75% colored; 5: yellow.

For the Pulp Firmness evaluation two measurements where done, one for External Firmness and another for Internal Firmness. For External Firmness, the papayas had the skin removed with a peeler and the pulp firmness was measured with a Firmness Texture Analyzer (FTA) with a probe of 8 mm. For Internal Firmness, the papayas were cut transversally and a measurement close to the center of the fruit was taken with the FTA.

TABLE 2-3
Pulp Firmness - Internal (lbf)

| | | Days @ 22° C. | | |
|---|---|---|---|---|
| Bag | ppb of MCP | 0 | 4 | 8 |
| No Bag | 0 | 5.6 | 1.0 | 1.0 |
| No Bag | 100 | 16.9 | 12.2 | 3.2 |
| MAP | 0 | 2.0 | 0.7 | 1.1 |
| MAP | 100 | 3.3 | 3.2 | 1.5 |

The desirable internal pulp firmness for consumption of papayas is between 2.5 and 7.0 lbf. The percentage of fruits with internal pulp firmness between 2.5 and 7.0 lbf was calculated.

TABLE 3
Percentage of fruits with ideal internal pulp firmness

| | | Days @ 22° C. | | |
|---|---|---|---|---|
| Bag | ppb of MCP | 0 | 4 | 8 |
| No Bag | 0 | 55.95 | 11.11 | 1.38 |
| No Bag | 100 | 1.19 | 11.11 | 58.33 |
| MAP | 0 | 42.85 | 5.55 | 8.33 |
| MAP | 100 | 52.38 | 44.44 | 13.88 |

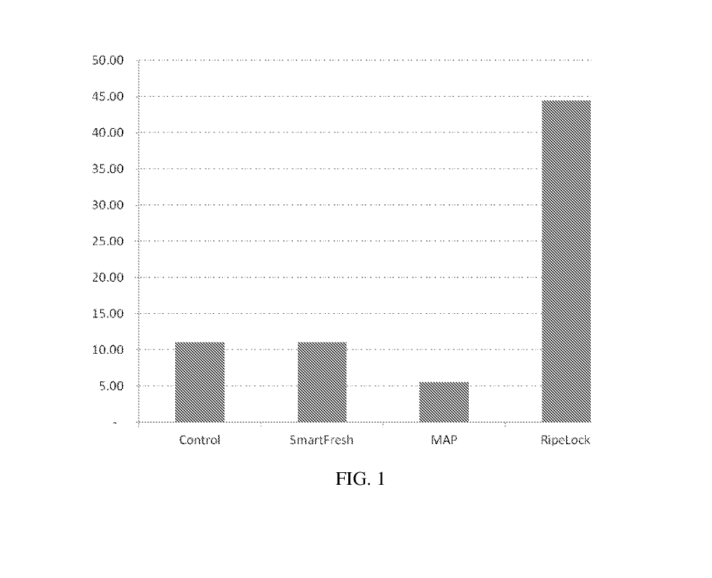

The results above show that the papayas treated by the method of the present invention have skin coloring delayed and external pulp firmness retention for a longer period of time than any other treatment. FIG. 1 also show percentage of papayas with ideal pulp firmness after four (4) days of shelf life (22° C.). The present invention also permitted the softening of the internal pulp firmness, what is important for the fruit reach consumption level.

Overall, our observations suggest that 1-MCP alone did not hold the papayas color and provided a too high internal firmness during shelf-life. MAP alone had an effect in papayas color development, however the fruits were soft at the beginning of shelf-life. The combined treatment was synergistic in holding color development and in the external firmness of the papayas that was maintained higher than the untreated fruits while the internal firmness reached a consumption level.

### Example 2

A similar test to Example 1 but papayas are tested during their yellow stage. Papayas ‘Golden’ were harvested in Linhares—Espírito Santo—Brazil. The fruits were packed in MAP Bags and put in cardboard boxes.

The fruits were first left at room temperature during 3 days to reach yellow maturity stage.

After that the appropriate weight of papayas was placed in each bag after harvest. Bags were placed in the same cardboard boxes used to export the fruits. Papayas then were cold stored at (11° C.) at the Laboratory.

The Test Protocol that was used was as follows. 18 MAP bags were packed. Each bag held approximately 3.8 kg (8.4 lb) of papayas. One such bag was packed in each cardboard box. Total weight of papayas in MAP bags was approximately 68 kg. Approximately 68 kg of papayas were placed into cardboard boxes identical to those used for the MAP bags.

The MAP-packaged papayas were packaged as follows: Nine fruits, approximately 3.8 kg were carefully placed into microperforated bags, and the bags were sealed by twisting the open side of the bag, folding down the twisted end, and placing a rubber band around the twisted and folded end of the bag.

After reach the yellow stage maturity the papayas presented a softer firmness. According to the FTA Machine (Firmness Texture Analyzer) the fruits had pulp firmness around 5.5 lbf at this stage.

All papayas were kept at cold temperature (11° C.) during 26 days and after that the fruits (packed in MAP bags or not) were put in room temperature (22° C.) during 8 days.

Bags were not opened until the day of the evaluation. Temperature was monitored in some of the cardboard boxes (CB) by placing a temperature monitor inside of the container.

The papayas were randomly divided into treatment sets as follows:

TABLE 4
Papaya treatment in this example

MCP Concentration

| Number of CBs | Bag Type | 0 ppb | 500 ppb |
|---|---|---|---|
| 18 CBs | No MAP | 9 CBs | 9 CBs |
| 18 CBs | MAP Bag | 9 CBs | 9 CBs |

The treatment group with MAP bags and with non-zero MCP are examples of the present invention. All other treatment groups are comparative.

After the 3 days for maturation at room temperature, when the papayas had around 5 lbf of average firmness, each treatment set was marked, placed in a hermetical chamber at cold temperature (11° C.). All chambers were of equal size and packed the same way. Treatment was for 12 hr. In the chambers for the 2 “MCP” treatment groups, at the beginning of the treatment period, SmartFresh™ were placed in the chamber. The amount of SmartFresh™ was chosen to achieve the indicated concentration of 1-methylcyclopropene in the atmosphere of the chamber.

After the treatment in the chambers, the cardboard boxes were moved into racks at positioned inside the cold rooms for storage and observation.

TABLE 5-1
Skin Color ratings

| | | Days @ 22° C. | | |
|---|---|---|---|---|
| Bag | ppb of MCP | 0 | 4 | 8 |
| No Bag | 0 | 3.98 | 5.00 | 5.00 |
| No Bag | 500 | 2.70 | 4.91 | 5.00 |
| MAP | 0 | 2.59 | 4.63 | 4.88 |
| MAP | 500 | 2.18 | 3.62 | 4.88 |

Papayas remained in the same bags throughout the packing, treatment in the chamber, and subsequent storage.

TABLE 5-2
Pulp Firmness - External (lbf)

| | | Days @ 22° C. | | |
|---|---|---|---|---|
| Bag | ppb of MCP | 0 | 4 | 8 |
| No Bag | 0 | 1.90 | 1.32 | 0.95 |
| No Bag | 500 | 3.03 | 1.88 | 1.11 |
| MAP | 0 | 2.15 | 1.37 | 1.08 |
| MAP | 500 | 3.84 | 1.98 | 1.30 |

Evaluation for skin color and firmness was as follows. Day “zero” was the day the papayas were removed from the chamber and placed in storage.

The Papaya Skin Color was rated with the following scale: 1: green; 2: approximately 25%; 3: approximately 50% colored; 4: approximately 75% colored; 5: yellow.

For the Pulp Firmness evaluation two measurements were done, one for External Firmness and another for Internal Firmness. For External Firmness, the papayas had the skin removed with a peeler and the pulp firmness was measured with a Firmness Texture Analyzer (FTA) with a probe of 8 mm. For Internal Firmness, the papayas were cut transversally and a measurement close to the center of the fruit was taken with the FTA.

TABLE 5-3
Pulp Firmness - Internal (lbf)

| | | Days @ 22° C. | | |
|---|---|---|---|---|
| Bag | ppb of MCP | 0 | 4 | 8 |
| No Bag | 0 | 1.19 | 0.87 | 0.83 |
| No Bag | 500 | 1.21 | 1.55 | 0.95 |
| MAP | 0 | 0.96 | 0.72 | 0.65 |
| MAP | 500 | 1.20 | 0.92 | 0.88 |

Weight loss was measured using the difference in weight observed in selected papayas from each treatment. These fruits were weighted before the cold storage and then the same fruits were weighted on the evaluations days.

TABLE 5-4
Weight loss (%)

| | | Days @ 22° C. | | |
|---|---|---|---|---|
| Bag | ppb of MCP | 0 | 4 | 8 |
| No Bag | 0 | 6.22 | 10.29 | 16.98 |
| No Bag | 500 | 5.42 | 9.07 | 16.53 |
| MAP | 0 | 1.34 | 1.69 | 2.38 |
| MAP | 500 | 0.68 | 1.21 | 2.09 |

The desirable internal pulp firmness for consumption of papayas is between 2.5 and 7.0 lbf. The percentage of fruits with internal pulp firmness between 2.5 and 7.0 lbf was calculated.

TABLE 6
Percentage of fruits with ideal internal pulp firmness

| | | Days @ 22° C. | | |
|---|---|---|---|---|
| Bag | ppb of MCP | 0 | 4 | 8 |
| No Bag | 0 | 8.51 | 0.00 | 0.00 |
| No Bag | 500 | 60.87 | 12.90 | 0.00 |
| MAP | 0 | 8.51 | 3.13 | 0.00 |
| MAP | 500 | 77.08 | 28.57 | 0.00 |

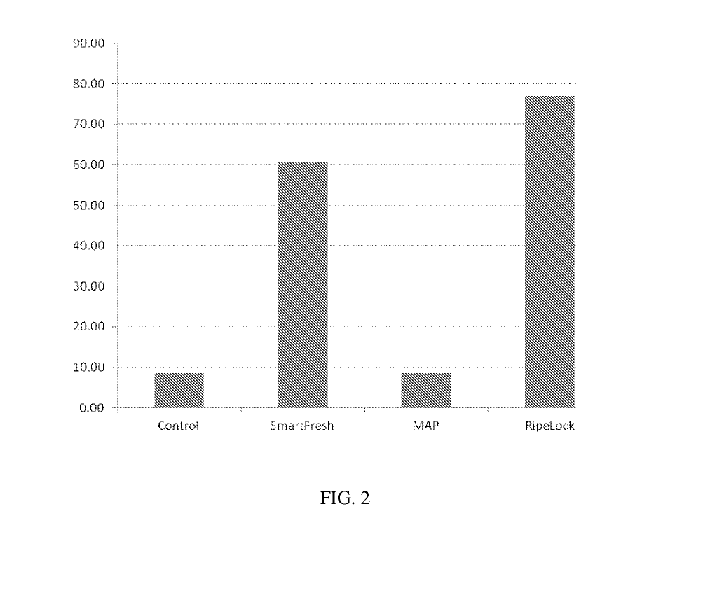

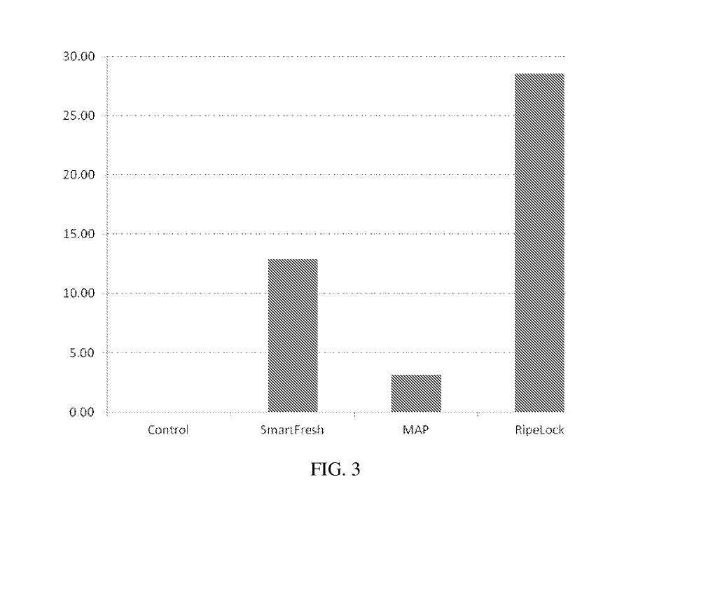

The results above show that the papayas treated by the method of the present invention have skin coloring delayed and external pulp firmness retention for a longer period of time than any other treatment. In addition, the present invention also prevented the weight loss and permitted the softening of the internal pulp firmness, what is important for the fruit reach consumption level. Percentages of papayas with ideal internal pulp firmness are also shown in FIGS. 2 and 3.

Results from this example show that 1-MCP alone did not hold the papayas color and had lower efficiency to maintain external firmness during shelf-life when compared to the present invention. Fruits treated with 1-MCP alone also presented an elevated weight loss. MAP alone did prevent weight loss and had a slight effect in papayas color development, however the fruits were soft at the very beginning of shelf-life. The combined treatment was synergistic in holding color development, external firmness, decreasing the percentage of weight loss of the papayas at least during 4 days at shelf-life conditions. And the combination of both technologies also presented a higher percentage of fruits with ideal firmness.

### Example 3

Papayas ‘Golden’ were harvested in Linhares—Espírito Santo—Brazil. The fruits were packed in MAP Bags and put in cardboard boxes.

The appropriate weight of papayas was placed in each bag after harvest. Bags were placed in the same cardboard boxes used to export the fruits. Papayas then were cold stored at (11° C.) at the Laboratory.

The Test Protocol that was used was as follows. 40 MAP bags were packed. Each bag held approximately 3.8 kg (8.4 lb) of papayas. One of such bag was packed in each cardboard box. Total weight of papayas in MAP bags was approximately 152 kg. Approximately 8 kg of papayas were placed into cardboard boxes identical to those used for the MAP bags.

The MAP-packaged papayas were packaged as follows: Nine fruits, approximately 3.8 kg, were carefully placed into microperforated MAP-bags, and the bags were sealed by twisting the open side of the bag, folding down the twisted end, and placing a rubber band around the twisted and folded end of the bag.

Papayas are harvest in an early mature stage with a high firmness. According to the FTA Machine (Firmness Texture Analyzer) the fruits had pulp firmness around 30 lbf one day after harvest.

All papayas were kept at cold temperature (11° C.) during 14 days and after that the fruits (packed in MAP bags or not) were put in room temperature (24° C.) during 5 days.

Bags were not opened until the day of the evaluation. Temperature was monitored in some of the cardboard boxes (CB) by placing a temperature monitor inside of the container.

The papayas were randomly divided into treatment sets as follows:

TABLE 7
Papaya treatment in this example

MCP Concentration

| Number of CBs | Bag Type | 0 ppb | 100 ppb |
|---|---|---|---|
| 10 CBs | No MAP | 5 CBs | 5 CBs |
| 10 CBs | 24 perforations | 5 CBs | 5 CBs |
| 10 CBs | 48 perforations | 5 CBs | 5 CBs |
| 10 CBs | 90 perforations | 5 CBs | 5 CBs |
| 10 CBs | 180 perforations | 5 CBs | 5 CBs |

One day after harvest, when the papayas had around 30 lbf of average firmness, each treatment set was marked and placed in a hermetical chamber at cold temperature (11° C.). All chambers were of equal size and packed the same way. Treatment was for 12 hours.

TABLE 8
Skin color ratings

Days @ 24° C.

| Bag | ppb of MCP | 0 | 3 | 5 |
|---|---|---|---|---|
| No Bag | 0 | 2.00 | 4.60 | 5.00 |
| No Bag | 100 | 1.82 | 4.11 | 4.96 |
| 24 Perf. | 0 | 2.16 | 3.62 | 4.48 |
| 48 Perf. | 0 | 1.67 | 4.33 | 4.84 |
| 90 Perf. | 0 | 1.64 | 3.42 | 4.52 |
| 180 Perf. | 0 | 1.80 | 3.89 | 4.76 |
| 24 Perf. | 100 | 1.60 | 2.04 | 3.75 |
| 48 Perf. | 100 | 1.96 | 3.02 | 4.52 |
| 90 Perf. | 100 | 1.71 | 3.18 | 4.36 |
| 180 Perf. | 100 | 1.73 | 4.13 | 4.84 |

In the chambers, SmartFresh™ was placed at the beginning of the treatment period for the 5 “MCP” treatment groups. The amount of SmartFresh™ was chosen to achieve the indicated concentration of 1-methylcyclopropene in the atmosphere of the chamber.

After the treatment in the chambers, the cardboard boxes were moved into racks and positioned inside the cold rooms for storage and observation.

Papayas remained in the same bags throughout the packing, treatment in the chamber, and subsequent storage.

Evaluation for skin color and firmness was as follows. Day “zero” was the day the papayas were removed from the chamber and placed in storage.

The Papaya Skin Color was rated with the following scale: 1: green; 2: approximately 25%; 3: approximately 50% colored; 4: approximately 75% colored; 5: yellow.

TABLE 9
Pulp Firmness - External (lbf)

Days @ 24° C.

| Bag | ppb of MCP | 3 | 5 |
|---|---|---|---|
| No Bag | 0 | 2.81 | 1.53 |
| No Bag | 100 | 6.23 | 2.62 |
| 24 Perf. | 0 | 1.36 | 1.39 |
| 48 Perf. | 0 | 1.84 | 1.61 |
| 90 Perf. | 0 | 3.38 | 2.30 |
| 180 Perf. | 0 | 2.54 | 1.55 |
| 24 Perf. | 100 | 5.23 | 4.12 |
| 48 Perf. | 100 | 3.68 | 2.42 |
| 90 Perf. | 100 | 3.94 | 3.28 |
| 180 Perf. | 100 | 3.64 | 2.80 |

For External Firmness, the papayas had the skin removed with a peeler and the pulp firmness was measured with a Firmness Texture Analyzer (FTA) with a probe of 8 mm.

The results show that the papayas treated by the method of the present invention have skin coloring delayed and external pulp firmness retention for a longer period of time than any treatment alone, demonstrating the synergistic effect from the combination of 1-MCP and MAP bag.

Results from this example show that 1-MCP alone did not hold the papayas color and provided a not high enough external firmness during shelf-life. MAP alone had an effect in papayas color development, however the fruits were soft at the beginning of shelf-life. The combined treatment was synergistic in holding color development and in the external firmness of the papayas that was maintained higher than the untreated fruits, especially when the 24 perforations bag was used.

TABLE 10
External Firmness (lbf) - Difference with Untreated Fruits (Δ)

5 Days @ 24° C.

| Bag | ppb of MCP | Firmness | Δ |
|---|---|---|---|
| No Bag | 0 | 1.53 | 0 |
| No Bag | 100 | 2.62 | 1.09 |
| 24 Perf. | 0 | 1.39 | −0.14 |
| 48 Perf. | 0 | 1.61 | 0.08 |
| 90 Perf. | 0 | 2.30 | 0.77 |
| 180 Perf. | 0 | 1.55 | 0.02 |
| 24 Perf. | 100 | 4.12 | 2.59 |
| 48 Perf. | 100 | 2.42 | 0.89 |
| 90 Perf. | 100 | 3.28 | 1.75 |
| 180 Perf. | 100 | 2.80 | 1.27 |

1. A method of increasing shelf life of papayas, said method comprising the steps of
i) exposing papayas to an atmosphere that consists essentially of a cyclopropene compound, wherein either:
(a) the papayas are located within a modified-atmosphere package during exposure to the cyclopropene compound, or
(b) the papayas are placed into a modified-atmosphere package after exposure to the cyclopropene compound,
wherein the modified-atmosphere package allows exchange of at least one gas with a second atmosphere that is outside the modified-atmosphere package and in contact with the modified-atmosphere package;
wherein the papayas remain in the modified atmosphere package for at least two hours after exposure to the cyclopropene compound; and
ii) thereafter placing the papayas at room temperature,
wherein the method results in an increased shelf life of the papayas at room temperature, wherein the increased shelf life comprises one or more of
a delay of skin color changes of the papayas observed within 8 days of placing the papayas at room temperature,
a softening of internal pulp firmness of the papayas for consumption observed within 8 days of placing the papayas at room temperature, or
a retention of external pulp firmness of the papayas observed within 8 days of placing the papayas at room temperature.

2. The method of claim 1, wherein the modified-atmosphere package has gas transmission that permits, for each kilogram of papaya, oxygen to be transmitted at a rate of from 200 to 40,000 cubic centimeters per day.

3. The method of claim 1, wherein the modified-atmosphere package has gas transmission that permits, for each kilogram of papaya, carbon dioxide to be transmitted at a rate of from 500 to 150,000 cubic centimeters per day.

4. The method of claim 1, wherein the modified-atmosphere package has a GT-30 or GT-25.4 for carbon dioxide at 23° C. from 800 to 150,000 cm³/(m²-day).

5. The method of claim 1, wherein the modified-atmosphere package has a GT-30 or GT-25.4 for oxygen at 23° C. from 200 to 150,000 cm³/(m²-day).

6. The method of claim 1, wherein the modified-atmosphere package has a GT-30 or GT-25.4 for water vapor at 37.8° C. from 5 to 1,000 g/(m²-day).

7. The method of claim 1, wherein the papayas are placed into a modified-atmosphere package within two hours after exposure to the cyclopropene compound.

8. The method of claim 1, wherein the cyclopropene compound is in a formulation with a molecular encapsulating agent.

9. The method of claim 1, wherein the cyclopropene compound is of the formula: 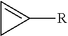
wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

10. The method of claim 9, wherein R is C₁₋₈ alkyl.

11. The method of claim 9, wherein R is methyl.

12. The method of claim 1, wherein the cyclopropene compound of the formula: 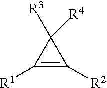
wherein R¹ is a substituted or unsubstituted C₁-C₄ alkyl, C₁-C₄ alkenyl, C₁-C₄ alkynyl, cycloalkyl, cycloalkylalkyl, phenyl, or naphthyl group; and R², R³, and R⁴ are hydrogen.

13. The method of claim 1, wherein the cyclopropene comprises 1-methylcyclopropene (1-MCP).

14. The method of claim 8, wherein the molecular encapsulating agent comprises alpha-cyclodextrin, beta-cyclodextrin, gamma-cyclodextrin, or combinations thereof.

15. The method of claim 1, wherein the concentration of the cyclopropene compound in the first atmosphere during the exposure is from 10 ppb to 5 ppm.

16. The method of claim 1, wherein the modified-atmosphere package has a thickness of 50 micrometers or less.

17. The method of claim 1, wherein the modified-atmosphere package has a thickness of about 25 micrometers or a thickness of about 30 micrometers.

18. The method of claim 1, wherein the method provides an improvement in the delay of skin color changes of the papayas observed within 4 days of placing the papayas at room temperature.

19. The method of claim 1, wherein the method provides an improvement in the softening of internal pulp firmness of the papayas for consumption observed within 4 days of placing the papayas at room temperature.

20. The method of claim 1, wherein the method provides an improvement in the retention of external pulp firmness of the papayas observed within 4 days of placing the papayas at room temperature.
